(19) United States
(12) Patent Application Publication
(10) Pub. No.: US 2025/0013219 A1
(43) Pub. Date: Jan. 9, 2025

(54) TOOL PATH MODIFICATION DEVICE AND TOOL PATH MODIFICATION METHOD

(71) Applicant: FANUC CORPORATION, Yamanashi (JP)

(72) Inventor: Kiwamu SAITOU, Yamanashi (JP)

(73) Assignee: FANUC CORPORATION, Yamanashi (JP)

(21) Appl. No.: 18/697,899

(22) PCT Filed: Oct. 26, 2021
(86) PCT No.: PCT/JP2021/039529

§ 371 Date: Apr. 2, 2024

(51) Int. Cl. G05B 19/404; G05B 19/4093

(52) U.S. Cl. CPC G05B 19/404; G05B 19/4093; G05B 2219/50336

(57) ABSTRACT

A tool path modification device according to an embodiment of the present disclosure, which enables high precision machining with a small computational load, is provided with: a tool path acquisition unit that acquires tool path information that specifies a tool path along which a tool for machining a workpiece travels using the coordinates of a plurality of command points through which the tool should pass; a command point adjustment unit that modifies the tool path information by changing the coordinates of the command points or adding or removing the command points; a curvilinearization section extraction unit that extracts, from the tool path information modified by the command point adjustment unit, a curvilinearization section for curvilinearizing the tool path; a tool path curvilinearization unit that replaces the information of the curvilinearization section in the tool path information modified by the command point adjustment unit with curve information; and a tool path output unit that outputs the tool path information after the tool path curvilinearization unit has replaced the information of the curvilinearization section.

### TECHNICAL FIELD

The present invention relates to a tool path modification device and a tool path modification method.

### BACKGROUND ART

To machine a workpiece with a tool on a machine tool, an NC program is created to control the machine tool from a numerical control device so that the tool is moved relatively according to a target shape (product shape) of the workpiece after machining, the target shape being generated by CAD, for example. Generally, an NC program for a numerical control device is created from CAD data by creating CL data describing the tool movement path from the CAD data in a CAM, and then converting the CL data into an NC program by a post-processor.

In CL data and NC programs, a tool movement path is generally described as a collection of multiple command points that specify the coordinates through which a reference point of the tool should pass. The machining points may be away from the target shape between command points, especially for portions where the curvature of the target shape is large. Also, the tool moves to scan the target shape, that is, repeatedly performs operations to move in a predetermined feed direction, shift position slightly in a direction intersecting the feed direction, and then move again in the feed direction. If there is a difference in the depth of cut between adjacent movement paths, minute steps are formed and an unintended pattern is formed on the surface of the workpiece after machining.

To suppress such machining error, a technology has been proposed to analyze a machining program and insert new command points between the command points described in the machining program, thereby reducing error in the depth of cut (see for example Patent Document 1).

### CITATION LIST

### Patent Document

Patent Document 1: PCT International Publication No. WO2018/020663

### DISCLOSURE OF THE INVENTION

### Problems to be Solved by the Invention

Inserting a large number of command points improves machining accuracy, but increases the computational load on the numerical control device. Therefore, it is desirable to have a technology that enables accurate machining even with a numerical control device that does not have high processing capacity.

### Means for Solving the Problems

A tool path modification device according to an aspect of the present disclosure is provided with: a tool path acquisition unit that acquires tool path information that specifies a tool path along which a tool for machining a workpiece travels using the coordinates of a plurality of command points through which the tool should pass; a command point adjustment unit that modifies the tool path information by changing the coordinates of the command points or adding or removing the command points; a curvilinearization section extraction unit that extracts, from the tool path information modified by the command point adjustment unit, a curvilinearization section for curvilinearizing the tool path; a tool path curvilinearization unit that replaces the information of the curvilinearization section in the tool path information modified by the command point adjustment unit with curve information; and a tool path output unit that outputs the tool path information after the tool path curvilinearization unit has replaced the information of the curvilinearization section.

A tool path modification method according to another aspect of the present disclosure is provided with: acquiring tool path information that specifies a tool path along which a tool for machining a workpiece travels using the coordinates of a plurality of command points through which the tool should pass; modifying the tool path information by changing the coordinates of the command points or adding or removing the command points; extracting, from the modified tool path information, a curvilinearization section for curvilinearizing the tool path; replacing the information of the curvilinearization section in the modified tool path information with curve information; and outputting the tool path information after the information of the curvilinearization section is replaced.

### Effects of the Invention

According to the present disclosure, it is possible to achieve high machining accuracy with a small computational load.

### BRIEF DESCRIPTION OF THE DRAWINGS

FIG. 1 is a block diagram illustrating a configuration of a machining system provided with a tool path modification device according to a first embodiment of the present disclosure;

FIG. 2 is a schematic diagram illustrating an example of a tool path generated by CAM;

FIG. 3 is a schematic diagram illustrating an example of adjusting the positions of command points on the tool path in FIG. 2;

FIG. 4 is a schematic diagram illustrating an example of adjusting the density of command points on the tool path in FIG. 3;

FIG. 5 is a schematic diagram illustrating an example of curvilinearization sections of the tool path in FIG. 2; and

FIG. 6 is a block diagram illustrating a configuration of a machining system provided with a tool path modification device according to a second embodiment of the present disclosure.

### PREFERRED MODE FOR CARRYING OUT THE INVENTION

### First Embodiment

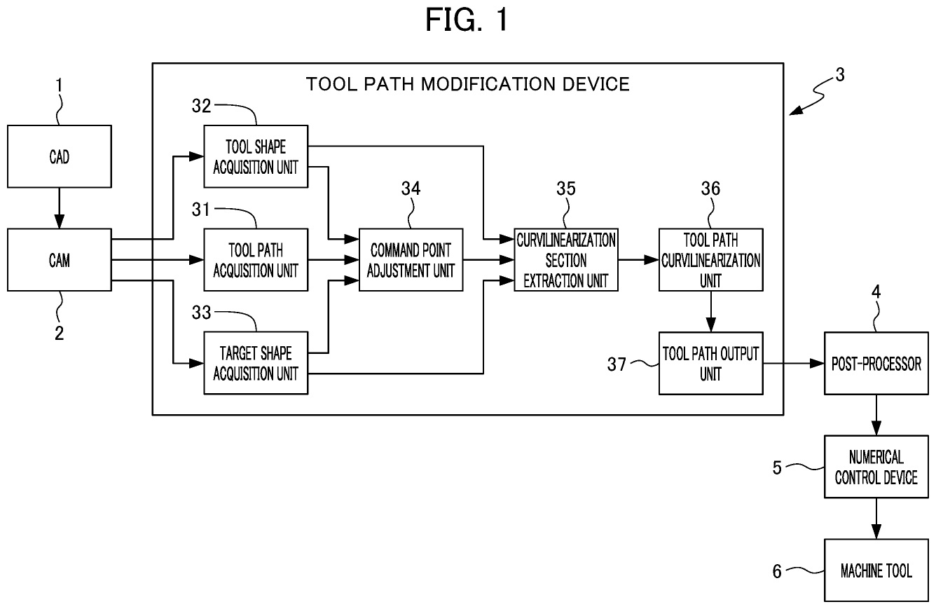

The following describes embodiments of the present disclosure with reference to the drawings. FIG. 1 is a block diagram illustrating a configuration of a machining system provided with a tool path modification device according to a first embodiment of the present disclosure. The machining system in FIG. 1 is provided with a CAD 1, a CAM 2, a tool path modification device 3 according to an embodiment of the present disclosure, a post-processor 4, a numerical control device 5, and a machine tool 6.

The CAD 1 is a well-known system in which computer equipment is used for designing. In other words, the CAD 1 is used to design a target shape (product shape), after machining, of a workpiece to be machined on the machine tool 6. The target shape may be specified by plane surfaces, cylindrical surfaces, spherical surfaces, Bezier surfaces, NURBS surfaces, or the like.

The CAM 2 is a well-known system that generates a machining program or the like to be used by the numerical control device 5 that controls the machine tool 6, so that the workpiece is machined by the machine tool 6 into the target shape designed using the CAD 1. The CAM 2 generates tool path information in which a tool path along which a tool for machining the workpiece is to move is specified by multiple command points through which the tool should pass. For this purpose, the CAM 2 may generate the shape of a machining area corresponding to the target shape created using the CAD 1. The tool path information may be generated in the format of CL (Cutter Location) data that does not consider the configuration and settings of individual machine tools 6. The CAM 2 may also be integrated with the computer device forming the CAD 1.

The tool path information may also include information about which portion of the tool is to move on the tool path. The portion (hereinafter referred to as the reference point) of the tool that is to move on the tool path may be the tool tip, the center of the tool shape (for example, the ball center of a ball end mill), or the like. The tool path information may also include information on whether the movement when the tool moves on the tool path is a cutting feed or a non-cutting feed (rapid traverse). Furthermore, the tool path information may also include information on the specific feed rate at which the tool moves on the tool path.

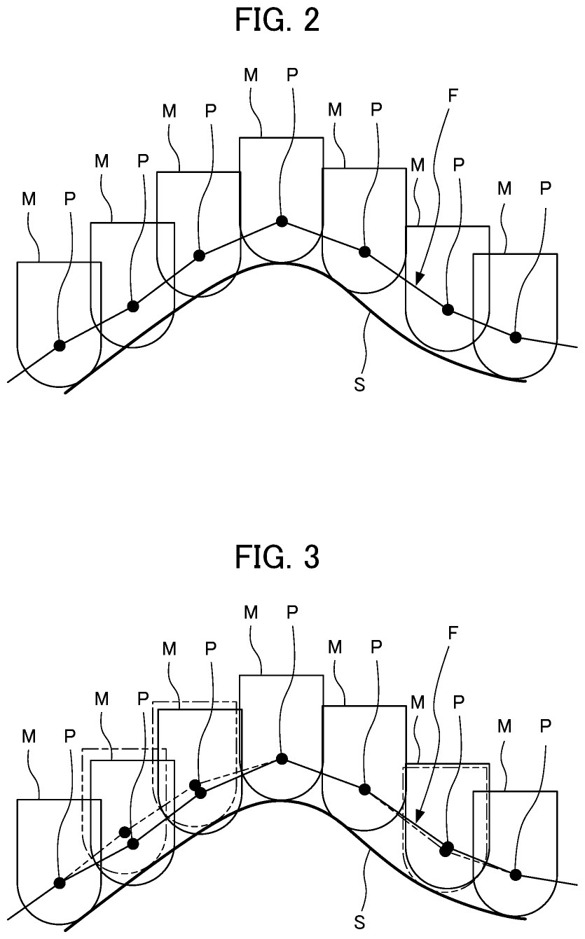

FIG. 2 illustrates a tool path F including multiple command points P. FIG. 2 illustrates the shape M of the tool at each command point P, and the target shape S. As illustrated in the diagram, the shape M of the tool at a command point P ideally contacts the target shape S, but in reality, may bite into the target shape S or move away from the target shape S.

The tool path modification device 3 has a tool path acquisition unit 31, a tool shape acquisition unit 32, a target shape acquisition unit 33, a command point adjustment unit 34, a curvilinearization section extraction unit 35, a tool path curvilinearization unit 36, and a tool path output unit 37. The tool path modification device 3 can be realized by, for example, causing a computer device provided with a CPU, memory, input/output interface, and the like to execute an appropriate control program. The tool path acquisition unit 31, tool shape acquisition unit 32, target shape acquisition unit 33, command point adjustment unit 34, curvilinearization section extraction unit 35, tool path curvilinearization unit 36, and tool path output unit 37 of the tool path modification device 3 are distinguished functionally, and do not have to be clearly distinguishable in terms of physical configuration and program structure. The tool path modification device 3 may also be integrated with another device such as the CAM 2 or the post-processor 4. In other words, the tool path modification device 3 may also be realized by adding a control program to the CAM 2, the post-processor 4, or the like. Note that the tool path modification device 3 is a device that carries out one form of a tool path modification method according to the present disclosure.

The tool path acquisition unit 31 acquires tool path information generated by the CAM 2. The tool path acquisition unit 31 may acquire tool path information via a server, recording medium, or the like not shown.

The tool shape acquisition unit 32 acquires tool shape information specifying the shape of the tool. The tool shape acquisition unit 32 can be configured to acquire tool shape information used by the CAM 2 to generate the tool path information. The tool shape acquisition unit 32 may also be configured to acquire tool shape information from a server, recording medium, or the like not shown.

The target shape acquisition unit 33 acquires target shape information specifying the target shape of the workpiece after machining. The target shape information may be information on a product shape generated in the CAD 1, or information on the shape of the machining area (such as the shape of a machined surface approximated as a set of multiple planes, for example) created by the CAM 2. In other words, the target shape acquisition unit 33 may acquire the target shape information from the CAD 1 or acquire the target shape information from the CAM 2. The target shape acquisition unit 33 may also acquire the target shape information from another device or a recording medium.

The command point adjustment unit 34 modifies the tool path information to reduce the difference between the tool path F and the target shape S when the tool moves on the path connecting the command points P with line segments by changing the coordinates of the command points P of the tool shape information acquired by the tool shape acquisition unit 32, or by adding or removing the command points P.

As illustrated by way of example in FIG. 3, the command point adjustment unit 34 may be configured to adjust the positions of the command points P on the basis of the tool shape information and the target shape information, so that the shape M of the tool contacts the target shape S. Note that “the shape of the tool contacts the target shape” means that a certain amount of error is tolerated and that the spacing or amount of overlap between the target shape S and the shape M of the tool is a certain value or less.

The command point adjustment unit 34 may move the command points P in the direction of the rotation axis of the tool. In many cases, moving the command points P in the direction of the rotation axis of the tool can reduce the computational load for position adjustment of the command points P. More precisely, the command point adjustment unit 34 may calculate the distance between the shape M of the tool and the target shape S at a command point P of the tool path F, and if the distance exceeds a tolerance value, the command point adjustment unit 34 may move the command point P in the direction of the rotation axis of the tool so that the shape M of the tool contacts the target shape S.

Also, the command point adjustment unit 34 may move the command points P in the normal direction of the target shape S. Moving the command points P in the normal direction of the target shape S can relatively reduce how much the command points P are moved. The command point adjustment unit 34 may also set a constraint plane in which the tool should be moved in that plane at the coordinates of the command points P, and move the command points P within the constraint plane.

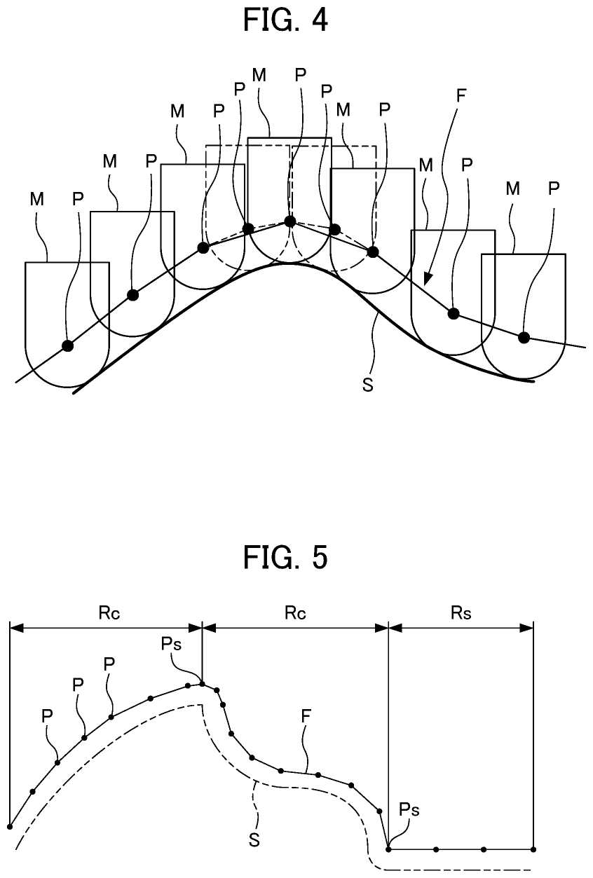

Also, as illustrated by way of example in FIG. 4, the command point adjustment unit 34 may further suppress the difference between the tool path F and the target shape S when the command points P are connected by line segments by generating modified path information in which command points P have been added and removed. In other words, the deviation of the tool path F from the target shape S can be reduced by adjusting the density of the command points P so that the larger the curvature of the target shape S is, the greater the density of the command points P becomes. Note that although increasing the number of command points P can bring the tool path F closer to the target shape S, it may be effective to reduce the density of the command points P in areas where the curvature of the target shape S is small to prevent excessive computational loads on the post-processor 4 and the numerical control device 5.

The curvilinearization section extraction unit 35 extracts curvilinearization sections to be curvilinearized by the tool path curvilinearization unit 36 from the tool path information (modified path information) after modification of the command points P by the command point adjustment unit 34. Specifically, as illustrated by way of example in FIG. 5, the curvilinearization section extraction unit 35 may be configured to set segmentation points Ps at which to segment the tool path F into a plurality of sections, and categorize the plurality of sections as curvilinearization sections Rc that should be curvilinearized and non-curvilinearization sections Rs that do not need to be curvilinearized. Note that the “tool path information after modification” is assumed to include the tool path information after processing in cases in which the modification-related processing is performed, but there is no change to the tool path information.

The curvilinearization section extraction unit 35 preferably extracts curvilinearization sections Rc so as not to straddle command points P corresponding to the edges of the shape of the workpiece after machining. In other words, it may be configured such that the tool path F is divided into sections with command points corresponding to the edges of the shape of the workpiece after machining as the segmentation points Ps, and from among these sections, sections where the curvature is equal to or larger than a predetermined value or sections where a cutting feed is performed, for example, are extracted as the curvilinearization sections Rc that should be curvilinearized.

The command points P where a switch occurs between a cutting feed and a non-cutting feed, the command points P before and after which the direction of tool travel changes by a threshold value or more, the command points P before and after which the ratio of the spacing between the command points P changes by a threshold value or more, and the like can be selected as the command points to be set as the segmentation points Ps. The segmentation points Ps may also be set by the command point adjustment unit 34 when repositioning the command points P.

In addition, the curvilinearization section extraction unit 35 may extract the curvilinearization sections Rc by setting, as the segmentation points Ps, points where the trend of curvature change in the tool path F changes, such as the start and end points of curvature change, inflection points of curvature change (points where positive and negative rates of change are reversed), and points where the rate of change changes discontinuously, for example.

The curvilinearization section extraction unit 35 may also extract the curvilinearization sections Rc by considering the target shape information. As an example, the curvilinearization section extraction unit 35 may be configured to extract the curvilinearization sections Rc by setting, as the segmentation points Ps, the command points P closest to the edges of the target shape S. By considering the target shape information, the command points P corresponding to the edges of the shape of the workpiece after machining can be identified easily and accurately.

The curvilinearization section extraction unit 35 may also extract the curvilinearization sections Rc by considering the tool shape information. If the orientation of the rotation axis of the tool is constant, and the target shape S has an edge, the tool path F draws a shape that is the inverse of the tool shape M to prevent the tool shape M from biting into the target shape S. Consequently, if the tool path F draws a shape that is the inverse of the tool shape M or a smaller shape, it can be determined that an edge will be formed on the shape of the workpiece after machining. Consequently, the command points P corresponding to the edges of the shape of the workpiece after machining can also be identified by considering the tool shape M. As an example, if the tool is a ball end mill, the segmentation points Ps may simply be set to the points where the curvature of the tool path F is less than or equal to the curvature of the tool shape M. Naturally, both the target shape information and the tool path can be used to extract the curvilinearization sections Rc more appropriately.

The tool path curvilinearization unit 36 replaces information about the curvilinearization sections Rc of the tool path information after modification of the command points P by the command point adjustment unit 34 with curve information. In other words, the tool path curvilinearization unit 36 represents the tool path F in the curvilinearization sections Rc not with a linear approximation connecting a plurality of command points P with line segments, but with a function approximation such as circular arcs, elliptical arcs, helical curves, spiral curves, involute curves, NURBS curves, or Bezier curves, for example. By using NURBS curves in particular, the difference between the tool path F and the target shape S can be reduced after the conversion into curve information, no matter what kinds of curves the tool path F and the target shape S are. Note that since the curves that can be supported may vary depending on the numerical control device 5, the tool path curvilinearization unit 36 selects the function to be used for curvilinearization according to the numerical control device 5.

In the case of using NURBS curves, the approximate curve of a curvilinearization section Rc is expressed by the following formula (1) in terms of the coordinates C(u₁) to C (Um) of m command points P, the coordinates P₁ to Pₕ of n control points, and the known B-spline basis function Ni (X).

$$[ Math . 1 ]$$

$$( \begin{matrix}C ( {u}_{1} ) \\ ⋮ \\ C ( {u}_{m} )\end{matrix} ) = ( \begin{matrix}{N}_{1} ( {u}_{1} ) & … & {N}_{n} ( {u}_{1} ) \\ ⋮ & ⋮ & ⋮ \\ {N}_{1} ( {u}_{m} ) & … & {N}_{n} ( {u}_{m} )\end{matrix} ) ( \begin{matrix}{P}_{1} \\ ⋮ \\ {P}_{n}\end{matrix} ) \qquad ( 1 )$$

In other words, the curvilinearization by the tool path curvilinearization unit 36 is a process of setting the n control points to the coordinates P₁ to Pₕ and replacing a curvilinearization section Rc of the tool path information with information specifying the above formula (1). Since a smaller number of control points tends to increase error, it is preferable to increase the number of control points by turns until the distance between the approximate curve and the command points P is a predetermined threshold value or less.

The tool path curvilinearization unit 36 may set a contribution for the command points P in the curvilinearization sections Rc and derive the curve information. In some cases, the coordinates of the command points P may deviate from the positions that exactly correspond to the intended target shape S due to error arising from computational accuracy, human error during modeling, error when importing data created on a different system, and the like. Such positional deviation is generally very small as distance error. However, when the distance between the command points P is small, such positional deviation may become relatively large as error in the angles of the line segments connecting the command points P. In such a case, setting a small contribution for command points P where the distance to adjacent command points P is small can prevent error in the command points P from creating large error in the derived curve.

Specifically, in the case of using NURBS curves, the approximate curve of a curvilinearization section Rc can be expressed by the following formula (2) in which a contribution de is set for the e-th command point P as an example.

$$[ Math . 2 ]$$

$$( \begin{matrix}C ( {u}_{1} ) \\ ⋮ \\ {α}_{e} \times C ( {u}_{e} ) \\ ⋮ \\ C ( {u}_{m} )\end{matrix} ) = ( \begin{matrix}{N}_{1} ( {u}_{1} ) & … & {N}_{n} ( {u}_{1} ) \\ ⋮ & ⋮ & ⋮ \\ {α}_{e} \times {N}_{1} ( {u}_{e} ) & … & {α}_{e} \times {N}_{n} ( {u}_{e} ) \\ ⋮ & ⋮ & ⋮ \\ {N}_{1} ( {u}_{m} ) & … & {N}_{n} ( {u}_{m} )\end{matrix} ) ( \begin{matrix}{P}_{1} \\ ⋮ \\ {P}_{n}\end{matrix} ) \qquad ( 2 )$$

In formula (2), if the contribution de is set to a value less than 1, the influence of the e-th command point P is relatively diminished. A contribution greater than 1 may also be set, and contributions may also be set for a plurality or all of the command points P.

The tool path output unit 37 stores the tool path information which has been modified by the command point adjustment unit 34 and in which information about the curvilinearization sections Rc has been replaced with curve information by the tool path curvilinearization unit 36, and outputs the stored information to the post-processor 4 as necessary.

The post-processor 4 converts the data format of the tool path information output from the tool path modification device 3 into a data format that can be processed by the numerical control device 5. Typically, the post-processor 4 converts tool path information described in the CL data format into a machining program described in G-code, STEP-NC, or the like.

The curve information in the tool path information is converted into corresponding function interpolation statements. Known equipment can be used as the post-processor 4.

The numerical control device 5 controls the machine tool 6 according to the tool path information input from the post-processor 4. Known equipment can be used as the numerical control device 5.

The machine tool 6 uses the tool to machine the workpiece according to instructions from the numerical control device 5. Known equipment can be used as the machine tool 6.

As above, by providing the machining system in FIG. 1 with the tool path modification device 3, the divergence width between the actually machined points and the target shape S is suppressed, and thus the workpiece can be machined into the target shape S with high accuracy. In addition, deviations in the depth of cut between adjacent tool paths F as the tool scans and moves across the surface of the workpiece is reduced, enabling highly accurate machining. This arrangement can suppress the formation of unintended patterns on the surface of the workpiece, thereby improving the aesthetics of the product obtained by machining the workpiece.

A tool path modification method according to an aspect of the present disclosure to be carried out by the tool path modification device 3 includes: acquiring tool path information that specifies a tool path F along which a tool for machining a workpiece travels using the coordinates of a plurality of command points P through which the tool should pass; modifying the tool path information by changing the coordinates of the command points P or adding or removing the command points P; extracting, from the modified tool path information, a curvilinearization section Rc for curvilinearizing the tool path F; replacing the information of the curvilinearization section Rc in the modified tool path information with curve information; and outputting the tool path information after the replacement of the information of the curvilinearization section Rc with the curve information.

### Second Embodiment

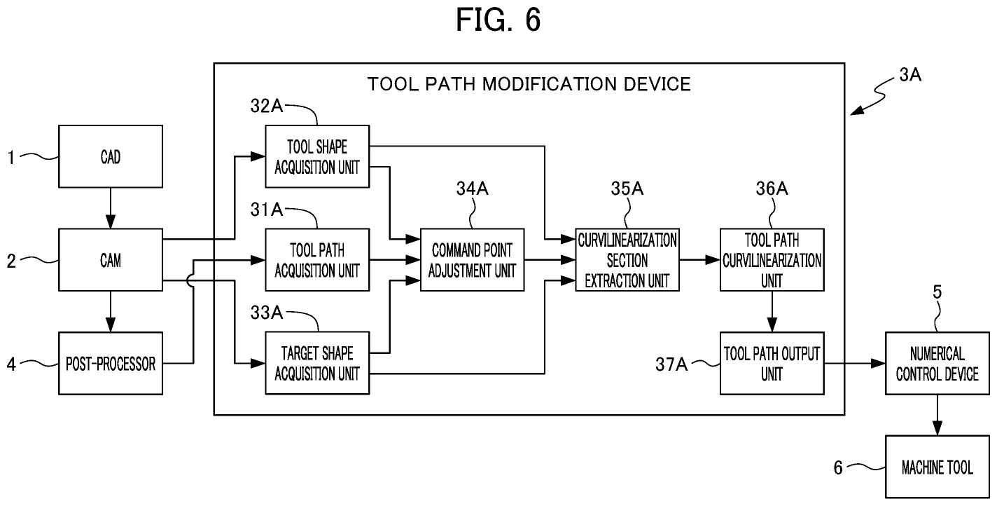

FIG. 6 is a block diagram illustrating a configuration of a machining system provided with a tool path modification device according to a second embodiment of the present disclosure. The machining system in FIG. 6 is provided with a CAD 1, a CAM 2, a tool path modification device 3A according to an embodiment of the present disclosure, a post-processor 4, a numerical control device 5, and a machine tool 6. Regarding the machining system in FIG. 6, components which are similar to those of the machining system in FIG. 1 are denoted with the same signs and duplicate description is omitted. In the machining system in FIG. 6, the tool path modification device 3A modifies a machining program described by, for example, G-code that the post-processor 4 inputs into the numerical control device 5.

The tool path modification device 3A is provided with a tool path acquisition unit 31A, a tool shape acquisition unit 32, a target shape acquisition unit 33, a command point adjustment unit 34A, a curvilinearization section extraction unit 35A, a tool path curvilinearization unit 36A, and a tool path output unit 37A. The tool path modification device 3A can be realized by, for example, causing a computer device provided with a CPU, memory, input/output interface, and the like to execute an appropriate control program, and may also be integrated with the post-processor 4, numerical control device 5, or the like.

The tool path acquisition unit 31A acquires tool path information from the post-processor 4. Consequently, the tool path acquired by the tool path acquisition unit 31A is in a format such as G-code, for example. The tool path acquisition unit 31A, command point adjustment unit 34A, curvilinearization section extraction unit 35A, tool path curvilinearization unit 36A, and tool path output unit 37A in the machining system of FIG. 6 differ from the tool path acquisition unit 31, command point adjustment unit 34, curvilinearization section extraction unit 35, tool path curvilinearization unit 36, and tool path output unit 37 in the machining system of FIG. 1 only in the data format to be handled, and are similar in function.

The foregoing describes embodiments of the present disclosure, but the present disclosure is not limited to the above embodiments. Moreover, the effects described in the above embodiments are merely a list of suitable effects arising from the present disclosure, and the effects of the present disclosure are not limited to those described in the above embodiments.

As an example, in the above embodiments, the command point adjustment unit adjusts the tool path information using the tool shape and the target shape, but the command point adjustment unit may be any unit that can improve the accuracy of the tool path information by adjusting the placement of command points. Accordingly, the tool shape acquisition unit and the target shape acquisition unit can be omitted from the tool path modification device in some cases.

Also, in the tool path modification device, the tool path information that the tool path acquisition unit acquires may be data in any format, such as a type used internally in a CAM, for example, and the tool path information that the tool path output unit outputs may be data in any format, such as a type used internally in a numerical control device, for example. Accordingly, the tool path modification device may also have a configuration to internally convert the data format of the tool path information.

### EXPLANATION OF REFERENCE NUMERALS

1 CAD
2 CAM
3 tool path modification device
4 post-processor
5 numerical control device
6 machine tool
31, 31A tool path acquisition unit
32 tool shape acquisition unit
33 target shape acquisition unit
34, 34A command point adjustment unit
35, 35A curvilinearization section extraction unit
36, 36A tool path curvilinearization unit
37, 37A tool path output unit
F tool path
M tool shape
P command point
Rc curvilinearization section
Rs non-curvilinearization section
S target shape

1. A tool path modification device comprising:
a tool path acquisition unit that acquires tool path information that specifies a tool path along which a tool for machining a workpiece travels using the coordinates of a plurality of command points through which the tool should pass;
a command point adjustment unit that modifies the tool path information by changing the coordinates of the command points or adding or removing the command points;
a curvilinearization section extraction unit that extracts, from the tool path information modified by the command point adjustment unit, a curvilinearization section for curvilinearizing the tool path;
a tool path curvilinearization unit that replaces the information of the curvilinearization section in the tool path information modified by the command point adjustment unit with curve information; and
a tool path output unit that outputs the tool path information after the tool path curvilinearization unit has replaced the information of the curvilinearization section.

2. The tool path modification device according to claim 1, wherein the curvilinearization section extraction unit extracts the curvilinearization section so as not to straddle the command points corresponding to edges of the shape of the workpiece after machining.

3. The tool path modification device according to claim 1,
further comprising a tool shape acquisition unit that acquires tool shape information that specifies the shape of the tool,
wherein the curvilinearization section extraction unit extracts the curvilinearization section by considering the tool shape information.

4. The tool path modification device according to claim 1, further comprising a target shape acquisition unit that acquires target shape information that specifies a target shape of the workpiece after machining, wherein the curvilinearization section extraction unit extracts the curvilinearization section by considering the target shape information.

5. The tool path modification device according to claim 1, wherein the tool path curvilinearization unit sets a contribution for the command points in the curvilinearization section.

6. A tool path modification method comprising:
acquiring tool path information that specifies a tool path along which a tool for machining a workpiece travels using the coordinates of a plurality of command points through which the tool should pass;
modifying the tool path information by changing the coordinates of the command points or adding or removing the command points;
extracting, from the modified tool path information, a curvilinearization section for curvilinearizing the tool path;
replacing the information of the curvilinearization section in the modified tool path information with curve information; and
outputting the tool path information after the information of the curvilinearization section is replaced.
